(19) United States
(12) Patent Application Publication
(10) Pub. No.: US 2009/0164172 A1
(43) Pub. Date: Jun. 25, 2009

(54) METHOD AND PROCESSING UNIT FOR DETERMINING A PERFORMANCE PARAMETER OF A BRAKE

(76) Inventors: Henry Hartmann, Gilching (DE); Leopold Krausen, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/293,995

(22) PCT Filed: Feb. 9, 2007
(86) PCT No.: PCT/EP2007/051241

§ 371 Date: Jan. 12, 2009

(30) Foreign Application Priority Data
Mar. 31, 2006 (DE) 10 2006 015 034.1

(51) Int. Cl. G01L 5/28; G06F 15/00; G01L 5/00

(52) U.S. Cl. 702/182; 73/121; 702/41

(57) ABSTRACT

A method for determining a performance parameter of a brake with a first (311) and a second (313) brake element can be made to interact to generate a friction force (F_{R}) and a friction torque (N_{R}), a first set (204a, 204b) of friction coefficients (μ) being determined between the first (311) and the second (313) brake element in the field, the first set (204a, 204b) of friction coefficients (μ) being compared with a predetermined second set (204) of friction coefficients (μ), and the performance parameter being determined based on a deviation of the first (204a, 204b) and second set (204), the deviation being obtained from the comparison.

### CROSS-REFERENCE TO RELATED APPLICATIONS

This application is a U.S. National Stage Application of International Application No. PCT/EP2007/051241 filed Feb. 9, 2007, which designates the United States of America, and claims priority to German Application No. 10 2006 015 034.1 filed Mar. 31, 2006, the contents of which are hereby incorporated by reference in their entirety.

### TECHNICAL FIELD

The invention relates to a method for determining a performance parameter of a brake, a corresponding processing unit, a corresponding computer program and a corresponding computer program product.

### BACKGROUND

There are a large number of different brakes in the prior art, for example brakes that can be operated by cable, linkage, hydraulic fluid or compressed air. In motor vehicles in particular, in addition to conventional hydraulically operated brakes, electric or electromechanical brakes are also used, with which the brake is no longer activated and released manually by the driver but electrically or electromechanically by an electric motor, for example (self-reinforcing) electromechanical disk brakes. With such disk brakes an electric actuator exerts an actuation force, which applies the friction linings of the brake to the rotating brake disk. An additional self-reinforcing facility that can be provided in the form of a wedge arrangement uses the kinetic energy contained in the rotating brake disk to apply the friction linings further, in other words the friction linings are pressed against the brake disk with a force that is much greater than the actuator force and is not applied by the electric actuator. The basic principle of such a disk is known from DE 198 19 564.

All the brakes mentioned share the feature that a first fixed brake element interacts with a second rotating brake element, for example friction lining/brake disk, brake shoe/brake cylinder etc., to generate a friction torque N_{R}. The interaction can be assigned a normal force F_{N}, which is perpendicular to the contact surface of the two brake elements, and a friction force F_{R}, which counters the relative movement between the two brake elements. The friction force is related by way of the distance r of the application point from the axis of rotation to the friction torque N_{R}, N_{R}=r·F_{R} and by way of a friction coefficient μ to the normal force, F_{R}=μ·F_{N} (Coulomb friction). It should be noted that for a floating caliper disk brake the relationship is F_{R}=2μ·F_{N}.

DE 101 51 950, to whose disclosure specific reference is made here, describes how the friction torque of an electromechanical wedge brake can be determined and the friction coefficient (friction value) can be ascertained. The result is used to regulate the braking force, in order to prevent the brake locking for example.

With brake systems, in particular vehicle brakes, the problem exists that braking capacity, in other words in particular the relationship between force applied and effective force, changes, in particular deteriorates over time. The decline in braking capacity can be compensated for by an increase in braking force or actuator force outlay for a certain period, until ultimately the safe operation of the brake system is no longer guaranteed and there is a loss of operating capacity. When a brake is used in the field, in other words for example in the motor vehicle after delivery to the customer, a decline in braking performance is generally not identified until dangerous situations or even an accident occur. Even tests in a workshop or test center can generally not reveal all the malfunctions that are possible with a brake. Such tests generally only take place at long time intervals.

### SUMMARY

According to various embodiments, a performance parameter for a brake system can be determined more accurately and earlier in the field in particular.

According to an embodiment, a method for determining a performance parameter of a brake with a first and a second brake element, which can be made to interact to generate a friction force and a friction torque, may comprise the following steps: Determining a first set of friction coefficients between the first and the second brake element in the field, Comparing the first set of friction coefficients with a predetermined second set of friction coefficients, and Determining the performance parameter based on a deviation of the first and second set, the deviation being obtained from the comparison.

According to a further embodiment, at least one of a normal force acting between the first and second brake elements, a temperature and a relative speed between the first and second brake element can be determined for each friction coefficient. According to a further embodiment, the temperature can be calculated or estimated or measured by means of a temperature sensor. According to a further embodiment, the relative speed can be measured by means of an in particular already present sensor. According to a further embodiment, the normal force can be measured by means of a force sensor arranged in the force flow of the normal force. According to a further embodiment, the friction coefficient is determined from the friction force and the normal force. According to a further embodiment, the performance parameter of a self-reinforcing or self-weakening brake can be determined, in which an actuator generating an actuator force is provided, which acts on the first brake element, to press the first brake element onto the second brake element, there being a dependency of the normal force on the actuator force and the friction value, a functional relationship is determined between the friction value and components of the normal force and components of the actuator force, the components of the normal force and the actuator force are determined and the friction coefficient is determined from the functional relationship, the determined components of the actuator force and the determined components of the normal force. According to a further embodiment, the actuator force or its components can be measured by means of a force sensor arranged in the force flow of the actuator force or can be determined from operating data of the actuator, in particular from the motor current of an electric motor associated with an electric actuator during actuation of the brake. According to a further embodiment, the actuator can be configured electrically, the second brake element as a rotatable brake disk and the first brake element as a friction lining, on which the electric actuator acts at an effective angle β by way of a wedge arrangement with a wedge angle α, to press the friction lining onto the brake disk. According to a further embodiment, the functional relationship can be determined as

$$μ = \frac{{F}_{N} tan α - {F}_{A} ( sin β + cos β tan α )}{{F}_{N}} ,$$

where μ designates the friction coefficient, F_{N} the amount of the normal force and F_{A} the amount of the actuator force.

According to another embodiment, a processing unit for determining a performance parameter of a brake with a first and a second brake element, which can be made to interact to generate a friction force and a friction torque, may comprise: Means for determining a first set of friction coefficients between the first and second brake element in the field, Storage means, which hold a predetermined second set of friction coefficients, Means for comparing the first set of friction coefficients with the second set of friction coefficients, Means for determining a deviation based on the comparison and Means for determining the performance parameter based on the deviation.

According to a further embodiment, the method may be executed as a program on a computer, a microprocessor or a corresponding processing unit.

According to yet another embodiment, a computer or microprocessor program product may comprise program code, which is stored on a machine or computer-readable data medium, wherein when said program code is executed on a computer or microprocessor the method as described above is performed.

### BRIEF DESCRIPTION OF THE DRAWINGS

FIG. 1 shows a schematic frequency diagram of friction coefficients for a simple form of the first or second set of friction coefficients;

FIG. 2a shows a first possible deviation between a first and a second set of friction coefficients;

FIG. 2b shows a second example of a possible deviation between a first and a second set of friction coefficients; and

FIG. 3 shows a schematic wedge arrangement of a self-reinforcing electromechanical brake for use with various embodiments.

### DETAILED DESCRIPTION

The descriptions and advantages set out below all relate to solutions according to various embodiments, unless it is specifically stated otherwise. The processing unit according to various embodiments has corresponding means for implementing the described steps.

According to various embodiments a performance parameter, in particular the operating capacity or working capacity, of a brake is determined. The brake has a first and a second brake element, which can be made to interact to generate a friction force and a friction torque. In the field a first set of friction coefficients (sliding friction coefficients) is determined between the first and second brake elements. The “determine in field” feature should be seen as a distinction from a determination by the manufacturer. According to various embodiments the determination is not carried out by the manufacturer but for example during normal driving operation, in a workshop or at a test center, for example a vehicle testing center. In this disclosure the term “determine” is in particular an umbrella term for “measure”, “estimate”, “calculate” etc., in other words any measure that supplies a result. The first set of friction coefficients is compared with a predetermined second set of friction coefficients. The first set is also referred to below as the “actual fingerprint” or “actual value” and the second set as the “setpoint fingerprint” or “setpoint value”. The performance parameter is finally determined based on a deviation between the first and second sets, the deviation being obtained from the comparison.

A friction value can in principle be determined from a comparison between friction force and normal force, as described above. Normal force can be determined for example by means of a sensor in the force flow. Friction force can be measured for example with a sensor, which is arranged between a friction lining of the brake and a component, on which the friction lining is supported during braking. Further possibilities are known to the competent person skilled in the art.

The relationship between setpoint fingerprint and deviation is set out below. If setpoint fingerprint (as a function of vehicle type and vehicle axle) is understood to be a lower limit of the friction coefficients (friction values), which still allows safe operation of the brake, a small deviation or a deviation of zero should be used accordingly. If however the setpoint fingerprint of new brake elements, for example a friction lining/brake disk combination, is used, the permissible deviation can be set correspondingly higher.

In a simple embodiment a fingerprint consists of a set of friction coefficients, which are considered as a function of their (relative) frequency. Generally this gives a distribution function, which can be approximated with a Gaussian function. In another embodiment a fingerprint consists of a first set of friction coefficients as a function of temperature, speed and force, as described for example in the paper “Method for extracting full spectrum of frictional material performance (Fingerprinting) using the SAE J2681” by Tim Duncan and Otto Schmitt, 22nd Annual Brake Colloquium & Exhibition, October 2004, Anaheim, Calif., USA, SAE Technical Papers Document Number: 2004-01-2768. Explicit reference is made to this publication, as it discloses how a fingerprint can be configured in further embodiments within the meaning of the present application. This method is used in turn to determine a frequency distribution of friction values. The frequency distribution corresponds typically to a (Gaussian) bell curve. It is possible to draw conclusions about the capacity (performance) of the brake system from the deviation of the actual fingerprint from the setpoint fingerprint. In these examples cited the deviation can be determined for example as a surface dimension or surface deviation, in other words it is determined which proportion of the surfaces below the curve overlap. This method described in SAE J2681 for determining fingerprints represents a very detailed method for determining friction values. In normal drive operation however not all braking situations generally occur, which correspond to a brake lining test for determining friction values according to this method. It is therefore possible for example just to use test methods which can be compared with the cited performance method. However it is also possible to carry out the friction value determination on a test bed (e.g. a rolling test bed), for example in a workshop or vehicle testing center, whereby a comprehensive fingerprinting test is possible. This means that a comprehensive and therefore very accurate test can advantageously be carried out.

It is however also possible and desirable to implement the method during normal drive operation. To determine the first set of friction values during normal drive operation the individual friction values should be collated. For every braking maneuver the friction value at the brake linings is stored together with the associated temperature, wheel speed and brake application force (normal force) in a storage unit (e.g. a microchip). To obtain additional friction values for other combinations of temperature, speed and normal force, the brake system can carry out automatic braking operations, in order to record the missing friction values required to create a first set in specific operating states. Such braking operations, preferably with little friction torque, can be initiated for short periods for example during an acceleration phase of the vehicle. In this instance only the acceleration of the vehicle would be reduced, which normally involves no potential risk. If carried out appropriately the braking effect could also be imperceptible to the driver.

The various embodiments provide for carrying out a setpoint/actual comparison between a predefined fingerprint and a determined fingerprint, preferably at regular intervals. The setpoint requirement is stored in the brake system, for example in a microchip, and can be read out at any time. Since the brake system, the brakes and therefore also the brake elements (brake linings, brake shoe, brake cylinder, brake drums, brake disks, etc.) have been designed individually for each vehicle (and for each vehicle axle) by the vehicle or brake manufacturer (or generally the OEM), an associated setpoint fingerprint can in principle be determined for every brake element combination. In other words every brake element combination associated with a brake can be characterized as a function of the vehicle type and the vehicle axle by a frequency distribution of friction values that is permanently predefined (by the manufacturer).

According to various embodiments the setpoint fingerprint (predefined by the manufacturer for example) for each brake in a vehicle is stored in a storage unit and can be called up at any time. In order to be able to start a setpoint/actual comparison, the vehicle or brake system must be able to determine an actual fingerprint for every brake element combination. To this end the friction value between the brake elements is determined, preferably as a function of the brake application force, temperature and relative speed.

If the braking performance falls below a specific setpoint value, specific measures can advantageously be initiated automatically, for example the driver can be informed that his/her brake is not in an ideal state. The solution according to various embodiments can be used to identify unsatisfactory brake elements, for example linings, which no longer achieve the desired performance. As well as normal wear, further physical conditions such as aging or vitrification cause increasing (creeping) deterioration. It is also simple to identify linings and/or brake disks, etc. that have been tampered with before fitting during a repair, which in turn significantly enhances the safety of the occupants. A self-diagnosis of the brake can be carried out before an upcoming major test or maintenance, thereby saving time and money. When a new brake element (brake lining, brake disk, brake shoe, brake cylinder, etc.) has been fitted, it can be identified and monitored. If the performance no longer satisfies the criteria of the setpoint fingerprint, an appropriate measure can be implemented.

In addition to the setpoint/actual comparison it is possible additionally or alternatively to carry out an actual comparison of all the brake elements in a vehicle. This can be done to ascertain whether the brake elements on one axle are of different quality (skewing of the vehicle on braking) or whether the front axle to rear axle braking ratio is correct.

Certain operating points of a brake can be determined by means of the performance measurement, e.g. start of fading, minimum and maximum friction value, etc.

Also the fingerprints of all the brakes can be stored as with a flight recorder and they can be used for accident analysis in the event of an accident.

Advantageous developments are set out in the subclaims and the description which follows.

A normal force F_{N} acting between the first and second brake elements, a temperature of the brake elements and a relative speed between the first and second brake elements is advantageously determined for each friction coefficient. The friction values of the first and second sets are therefore present as a function of the parameters mentioned. The sliding friction coefficient is theoretically independent of the sliding speed and therefore constant. In practice however a dependency on temperature, speed and force or pressure can be determined. The friction coefficients are therefore preferably determined as a function of these parameters, in order to be able to carry out a more accurate comparison of the friction coefficients.

It is expedient if the temperature, in particular at the boundary surface of the two brake elements, is calculated or estimated or measured using a sensor. A calculation or estimation can be derived and carried out simply by way of temperature models. The frictional heat can be calculated using the friction force and friction path. Material parameters, in particular thermal capacity, etc., of the brake elements are also likewise known. The friction path results from the distance covered. Generally therefore the heat induced in the brake system by way of brake friction can be estimated and the temperature calculated therefrom. It is also possible in a simple manner to provide a temperature sensor, for example on the brake disk.

The relative speed is expediently measured by means of a sensor. To this end the rotation speed of the brake disk for example can be determined, from which it is simple to calculate the relative speed by way of the radius. It is particularly advantageous to use sensors that are already present. For example speed is likewise determined by a sensor in the ABS system or by a tachometer. No additional sensor is then advantageously necessary.

The normal force is expediently measured by means of a force sensor arranged in the force flow of the normal force. The determination gives in particular the components of the normal force, for example in Cartesian, cylindrical or spherical coordinates, as well as their amount. For example the normal force can be measured in the friction linings themselves or in or on the lining supports, as well as on the support surfaces of the wedge in the wedge arrangement, in the caliper over the brake disk or even in the frame of the disk brake. In general it is advantageous to measure forces close to the point of origin, to avoid falsification of the measuring signals due to inert masses. However the normal force can also be determined indirectly, for example from the degree of displacement of a wedge in the wedge arrangement of a wedge brake for a given braking operation. During a braking process the normal force results in a widening of the caliper of the disk brake and a compression of the brake linings and to a lesser degree also the brake disk. These elasticities of the brake are compensated for by a corresponding displacement of the wedge in the actuation direction. If the term “zero position” refers to the position of the friction lining in which the so-called air gap is just overcome and the friction linings therefore rest in a force-free manner on the brake disk, it is possible to calculate the normal force directly from the degree of displacement of the wedge in the actuation direction. If the spring characteristic of the brake in the system is linear, the normal force is directly proportional to the displacement path of the wedge. The displacement path of the wedge can either be measured directly or can be determined from operating data of the actuator. For example it is possible to calculate the displacement path of the wedge from the engine rotation angle or an electric motor associated with the actuator, in particular when the electric motor acts on the wedge by way of a gradient-true advance system. Alternatively or additionally the widening of the brake caliper can be determined using a commercially available position measuring system. As the relationship between the widening of the brake caliper and the effective normal force is linear for practical purposes, measurement of the widening of the brake caliper represents a further option for determining the normal force.

According to a further embodiment the friction coefficient is determined from the friction force and normal force and the friction force in particular is measured by a force sensor, which in particular detects the support force of the brake during braking. As described above, the friction coefficient is related to the friction force by way of the normal force. By determining the friction force and normal force to determine the friction coefficient the various embodiments can in principle be used with almost every mechanical friction brake.

In one embodiment a performance parameter of a self-reinforcing or self-weakening brake is determined, for which an actuator generating an actuator force is provided, which acts on the first brake element to press the first brake element onto the second brake element, resulting in a dependency of the normal force on the actuator force and the friction value. In this instance a functional relationship is determined between the friction value and components of the normal force and components of the actuator force, the components of the normal force and actuator force are determined and the friction coefficient is determined from the functional relationship, the determined components of the actuator force and the determined components of the normal force. This embodiment allows a friction coefficient to be determined for every self-weakening or self-reinforcing brake, for which there is a dependency of the normal force on the actuator force and the friction value. The invention is therefore not restricted to wedge brakes for example but can also be used for servo brakes, duoservo brakes, etc. An actuator generally converts control signals to mechanical work. The actuator can in particular be configured as an (electric) motor, a hydraulic or pneumatic cylinder, a piezoactuator (translator), etc.

According to one embodiment the actuator force or its components is/are measured by means of a force sensor arranged in the force flow of the actuator force or determined from operating data of the actuator, in particular from the motor current of an electric motor associated with the actuator during actuation of the brake. The force sensor can for example detect the reaction force with which an electric motor associated with the actuator is supported on the housing of the actuator or brake. The reaction force corresponds to the actuator force apart from the sign. The force sensor can however also be arranged at the point where the actuator force is induced in the wedge of the wedge arrangement. Likewise a force sensor can be arranged in or on a force transmission means of the actuator, for example on a spindle or a tension or compression rod. However the actuator force does not have to be measured directly but can be determined indirectly, for example from the motor current of the electric motor associated with the actuator. The motor current is a measure of the torque emitted by the motor, which is converted to an axial force by a spindle drive for example. The motor current is therefore proportional to the generated actuator force. Such an indirect determination of the actuator force is an appropriate and favorable solution, if accuracy requirements are not too stringent. The force sensor can operate as a direct force or elongation sensor, for example capacitively (piezo), resistively (DMS) or by way of a hydraulic pressure sensor. It can also operate by means of path measurement by way of eddy current, inductively, capacitively or magnetically. Such power sensors can be robust even though they are small in size and are therefore easy to apply to the brake system.

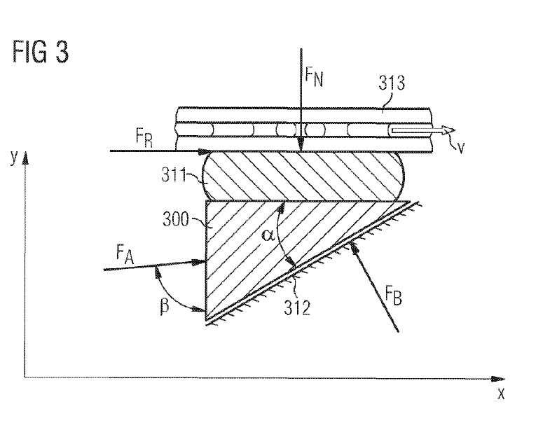

In a further embodiment the actuator is configured electrically, the second brake element as a rotatable brake disk and the first brake element as a friction lining, on which the electric actuator acts at an effective angle β by way of a wedge arrangement with a wedge angle α, to press the friction lining onto the brake disk. The effective angle refers to the angle between the actuator force and the normal force. The proposed method can be used particularly simply in the specific instance β=90° for wedge brakes, since with wedge brakes, in which the actuator force acts perpendicular to the normal force and therefore parallel to the friction force, the friction coefficient can be determined particularly simply as a function of the actuator force and the wedge angle. Such a determination method is described in detail in the above-mentioned DE 101 51 950, to which express reference is made again. In order not to have to repeat the entire DE 101 51 950 at this point, only the essential results are given in brief. The competent person skilled in the part can consult DE 101 51 950 to clarify any open questions. According to DE 101 51 950 the friction coefficient μ can be determined as μ=tan α−F_{A}/F_{N} based on the wedge angle α, the normal force F_{N} and the actuator force F_{A}. The actuator force can be determined for example from the actuator power consumption, the normal force by means of a force sensor. Also according to the above-mentioned embodiment the temperature at the boundary surfaces between the brake disk and the friction lining, approximately the temperature of the brake disk, and a rotation speed of the brake disk can be determined for each friction coefficient. The rotation speed ω of the brake disk is proportional to the sliding speed v (tangential speed) of the friction lining on the brake disk according to v=ωr, as is commonly known to every competent person skilled in the art. r characterizes the distance of the friction lining from the axis of rotation. A method for determining a friction coefficient for any angle β is described below based on FIG. 3.

The functional relationship is advantageously determined as

$$μ = \frac{{F}_{N} tan α - {F}_{A} ( sin β + cos β tan α )}{{F}_{N}} ,$$

where μ designates the friction coefficient, F_{N} the amount of the normal force and F_{A} the amount of the actuator force. It is therefore possible to determine the friction coefficient for wedge brakes with any effective angle in a particularly simple manner.

A processing unit according to various embodiments has calculation means to carry out the steps of the method, in particular means for determining a first set of friction coefficients between the first and second brake elements in the field, storage means holding a predetermined second set of friction coefficients, means for comparing the first set of friction coefficients with the second set of friction coefficients, means for determining a deviation based on the comparison and means for determining the performance parameter based on the deviation. The processing unit can be configured in particular as a control device in a motor vehicle.

The method and the processing unit according to various embodiments are preferably used in an embedded system, control device or ECU in a motor vehicle.

A computer or microprocessor program according to various embodiments contains program code means to implement the method, when the program is executed on a computer, a microprocessor or a corresponding processing unit, in particular the processing unit.

An computer or microprocessor program product according to various embodiments contains program code means, which are stored on a machine or computer-readable data medium, to implement the method, when the program product is executed on a computer, a microprocessor or a corresponding processing unit, in particular the processing unit. Suitable data media are in particular diskettes, hard disks, flash memories, EEPROMs, CD-ROMs, etc. It is also possible to download a program by way of computer networks (internet, intranet, etc.) and vehicle networks (Body-Bus, Infotainment-Bus etc.).

Further advantages and embodiments will emerge from the description and accompanying drawing.

It is evident that the above-mentioned features and those still to be described below can be used not only in the respectively specified combination but also in other combinations or alone, without departing from the scope of the present invention. The invention is illustrated schematically in the drawing based on an exemplary embodiment and is described in detail below with reference to the drawing.

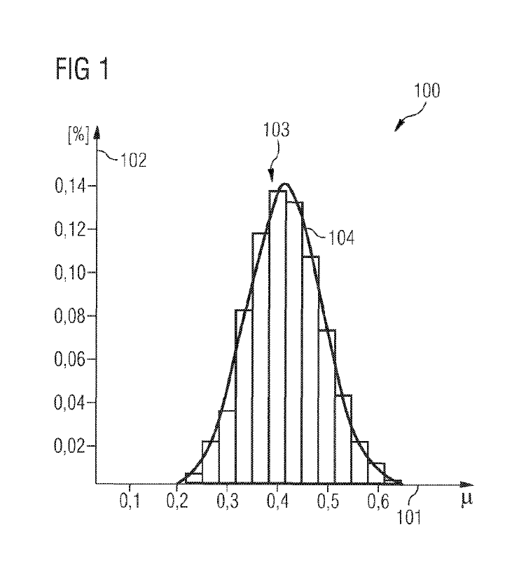

FIG. 1 shows a diagram illustrating a relationship between friction values of a first or second set of friction values and the associated relative frequency, designated as a whole by 100. In the diagram 100 friction values are plotted for a predetermined combination of normal force, temperature and speed. The friction values μ are plotted on an x-axis 101, which comprises values from 0-1, against the relative frequency on a y-axis 102.

In the diagram shown the friction values are not continuous but are plotted in steps 103 of 1/15. For example all the friction values from μ= 11/30 (0.37) to μ= 13/30 (0.43) are combined in one step. A relative frequency of approx. 0.14 is assigned to this friction value μ=0.4.

The width of the steps, in the illustrated diagram for example 1/15, is the result for example of the measuring accuracy or the nature of the plotting, as is clear to any competent person skilled in the art. The stepped plotting of the friction values can be approximated by an enveloping curve 104. The curve form of the curve 104 corresponds essentially to a Gaussian bell form. In the present example the maximum is around a friction value of μ=0.42.

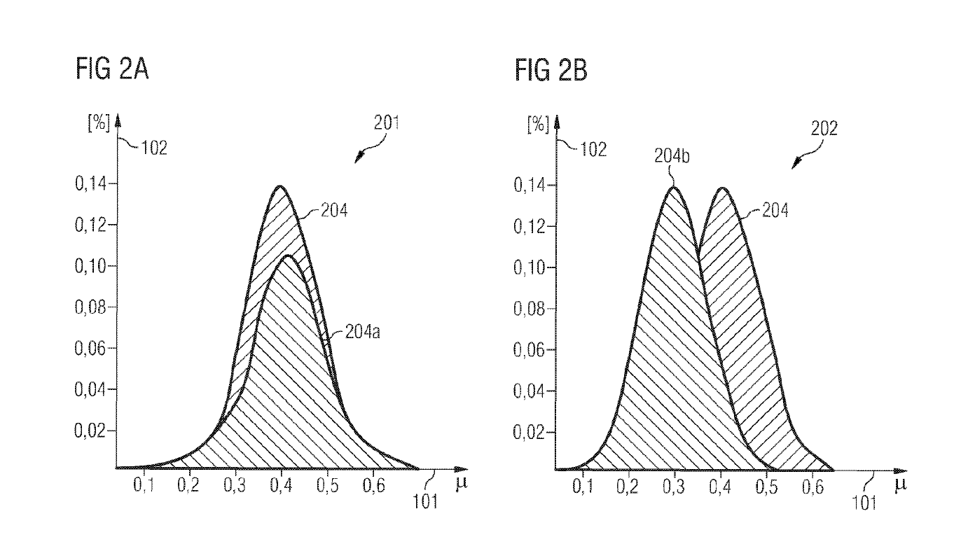

FIGS. 2a and 2b show two of the possible deviations of the first from the second set of friction values. A large number of further deviations is also possible, as is evident to any person skilled in the art.

FIG. 2a in turn shows the friction values together with their respective relative frequency in a diagram 201. The predetermined second set of friction values, the actual fingerprint, is characterized by a curve 204. The determined first set of friction values is characterized by a curve 204a. In the diagram the deviation of the first set from the second set is clearly identifiable. In the example shown friction values with a value μ between approximately 0.25 and 0.52 occur less frequently in the first set than in the second set, while friction values smaller than approximately 0.25 and greater than approximately 0.52 occur more frequently in the first set than in the second set. It can be concluded from the deviation shown that the friction lining used does not correspond to the prescribed friction lining, from which the setpoint fingerprint was determined. It could be a different type or it could have been tampered with.

FIG. 2b shows a diagram 202 illustrating the friction values and their associated relative frequency for a predetermined second set 204 and a determined first set 204b. In the diagram shown the maximum for the relative frequency in the determined first set is displaced toward smaller friction values μ. The curve form of the curve 204b is essentially identical to that of the curve 204. This illustrated deviation is produced for example by a worn friction lining.

FIG. 3 shows a wedge arrangement, which is suitable for use in a self-reinforcing, electromechanical brake, as is also disclosed in DE 101 51 950. An electric actuator, which generally comprises an electric motor and a spindle drive, generates an actuation or actuator force F_{A}, which is induced in a wedge 300 at an effective angle β, to displace the wedge in x-direction (to the right in the diagram). A friction lining 311 rests on one lateral face, an abutment 312 to support the wedge on another lateral face of the wedge 300. The actuator force F_{A} displaces the wedge 300 having a wedge angle β in x-direction, with the result that the friction lining 311 comes into contact with a brake disk 313 rotating at speed v. As soon as the friction lining 311 touches the brake disk 313, a reflected or normal force F_{N} results normal to the brake disk as well as a friction force F_{R} acting in the circumferential direction of the brake disk 313. These forces are for the most part induced in the abutment or housing of the brake and supported there, resulting in a support force F_{B}.

Taking into account the forces acting in the x-direction at the wedge, the following results:

μF_{N}+F_{A} sin β−F_{B} sin α=0 (1)

Taking into account the forces acting in the y-direction at the wedge, the following results:

F_{B} cos α+F_{A} cos β−F_{N}=0 (2)

Defining (2) according to F_{B}:

$${F}_{B} = \frac{{F}_{N} - {F}_{A} cos β}{cos α} \qquad ( 3 )$$

and inserting it in (1):

μF_{N}+F_{A} sin β−(F_{N}−F_{A} cos β)tan α=0

gives the functional relationship for μ:

$$μ = \frac{( {F}_{N} - {F}_{A} cos β ) tan α - {F}_{A} sin β}{{F}_{N}}$$

$$μ = tan α - \frac{{F}_{A}}{{F}_{N}} ( sin β + cos β tan α )$$

with the two specific instances:

$$β = {0}^{°} \text{:}$$

$$μ = tan α ( 1 - \frac{{F}_{A}}{{F}_{N}} )$$

$$β = {90}^{°} \text{:}$$

$$μ = tan α - \frac{{F}_{A}}{{F}_{N}}$$

It is thus possible to determine a first set of friction values for a wedge brake with any angles α and β from the amounts of the actuator force and the normal force.

What is claimed is:

1. A method for determining a performance parameter of a brake with a first and a second brake element, which can be made to interact to generate a friction force and a friction torque, comprising the following steps:
Determining a first set of friction coefficients between the first and the second brake element in the field,
Comparing the first set of friction coefficients with a predetermined second set of friction coefficients, and
Determining the performance parameter based on a deviation of the first and second set, the deviation being obtained from the comparison.

2. The method as according to claim 1, wherein at least one of a normal force acting between the first and second brake elements, a temperature and a relative speed between the first and second brake element being determined for each friction coefficient.

3. The method according to claim 2, wherein the temperature is calculated or estimated or measured by means of a temperature sensor.

4. The method according to claim 2, wherein the relative speed is measured by means of a sensor or an already present sensor.

5. The method according to claim 1, wherein the normal force is measured by means of a force sensor arranged in the force flow of the normal force.

6. The method according to claim 1, wherein the friction coefficient is determined from the friction force and the normal force.

7. The method according to claim 2, wherein the performance parameter of a self-reinforcing or self-weakening brake is determined, in which an actuator generating an actuator force is provided, which acts on the first brake element, to press the first brake element onto the second brake element, there being a dependency of the normal force on the actuator force and the friction value, a functional relationship is determined between the friction value and components of the normal force and components of the actuator force, the components of the normal force and the actuator force are determined and the friction coefficient is determined from the functional relationship, the determined components of the actuator force and the determined components of the normal force.

8. The method according to claim 7, wherein the actuator force or its components is/are measured by means of a force sensor arranged in the force flow of the actuator force or is/are determined from operating data of the actuator, in particular from the motor current of an electric motor associated with an electric actuator during actuation of the brake.

9. The method according to claim 7, wherein the actuator is configured electrically, the second brake element as a rotatable brake disk and the first brake element as a friction lining, on which the electric actuator acts at an effective angle β by way of a wedge arrangement with a wedge angle α, to press the friction lining onto the brake disk.

10. The method according to claim 9, wherein the functional relationship is determined as
$$μ = \frac{{F}_{N} tan α - {F}_{A} ( sin β + cos β tan α )}{{F}_{N}} ,$$
where μ designates the friction coefficient, F_{N} the amount of the normal force and F_{A} the amount of the actuator force.

11. A processing unit for determining a performance parameter of a brake with a first and a second brake element, which can be made to interact to generate a friction force and a friction torque comprising:
Means for determining a first set of friction coefficients between the first and second brake element in the field,
Storage means, which hold a predetermined second set of friction coefficients,
Means for comparing the first set of friction coefficients with the second set of friction coefficients,
Means for determining a deviation based on the comparison and
Means for determining the performance parameter based on the deviation.

12. The method according to claim 1, wherein the method is executed as a program on a computer, a microprocessor or a corresponding processing unit.

13. A computer or microprocessor program product comprising program code, which is stored on a machine or computer-readable data medium, wherein when said program code is executed on a computer or microprocessor a performance parameter of a brake with a first a first and a second brake element, which can be made to interact to generate a friction force and a friction torque, is determined by:
Determining a first set of friction coefficients between the first and the second brake element in the field,
Comparing the first set of friction coefficients with a predetermined second set of friction coefficients, and
Determining the performance parameter based on a deviation of the first and second set, the deviation being obtained from the comparison.

14. The computer or microprocessor program product according to claim 13, wherein at least one of a normal force acting between the first and second brake elements, a temperature and a relative speed between the first and second brake element being determined for each friction coefficient.

15. The computer or microprocessor program product according to claim 14, wherein the temperature is calculated or estimated or measured by means of a temperature sensor.

16. The computer or microprocessor program product according to claim 14, wherein the relative speed is measured by means of an in particular already present sensor.

17. The computer or microprocessor program product according to claim 13, wherein the normal force is measured by means of a force sensor arranged in the force flow of the normal force.

18. The computer or microprocessor program product according to claim 13, wherein the friction coefficient is determined from the friction force and the normal force.

19. The computer or microprocessor program product according to claim 14, wherein the performance parameter of a self-reinforcing or self-weakening brake is determined, in which an actuator generating an actuator force is provided, which acts on the first brake element, to press the first brake element onto the second brake element, there being a dependency of the normal force on the actuator force and the friction value, a functional relationship is determined between the friction value and components of the normal force and components of the actuator force, the components of the normal force and the actuator force are determined and the friction coefficient is determined from the functional relationship, the determined components of the actuator force and the determined components of the normal force.

20. The computer or microprocessor program product according to claim 19, wherein the actuator force or its components is/are measured by means of a force sensor arranged in the force flow of the actuator force or is/are determined from operating data of the actuator, in particular from the motor current of an electric motor associated with an electric actuator during actuation of the brake.
